(19) United States
(12) Patent Application Publication
(10) Pub. No.: US 2024/0403617 A1
(43) Pub. Date: Dec. 5, 2024

(54) COMPUTING DEVICE, NEURAL NETWORK SYSTEM, NEURON MODEL DEVICE, COMPUTATION METHOD, AND TRAINED MODEL GENERATION METHOD

(71) Applicant: NEC Corporation, Minato-ku, Tokyo (JP)

(72) Inventor: Yusuke Sakemi, Tokyo (JP)

(73) Assignee: NEC Corporation, Minato-ku, Tokyo (JP)

(21) Appl. No.: 18/699,620

(22) PCT Filed: Oct. 18, 2021
(86) PCT No.: PCT/JP2021/038475

§ 371 Date: Apr. 9, 2024

(51) Int. Cl. G06N 3/049

(52) U.S. Cl. CPC G06N 3/049

(57) ABSTRACT

A computing device includes: a multilayer spiking neural network including a plurality of neurons. and includes an additive computing portion in which a lower limit of membrane potential of the neurons in each layer is suppressed by learning.

### TECHNICAL FIELD

The present invention relates to a computing device, a neural network system, a neuron model device, a computation method, and a trained model generation method.

### BACKGROUND ART

One type of neural network is the Spiking Neural Network (SNN). For example, Patent Document 1 describes a neuromorphic computing system that implements a spiking neural network on a neuromorphic computing device.

In spiking neural networks, neuron models have internal states called membrane potentials and output signals called spikes based on the temporal evolution of membrane potentials. Such neuron models may be realized using virtual circuit models based on Kirchhoff's rule or actual analog circuits. Such discrepancies between the behavior of the virtual circuit model and that of the actual circuit could result in reduced analysis accuracy.

### PRIOR ART DOCUMENTS

### Patent Documents

Patent Document 1: Japanese Unexamined Patent Application, First Publication No. 2018-136919

### SUMMARY OF THE INVENTION

### Problems to be Solved by the Invention

The behavior of the circuit model corresponding to each neuron model comprising the spiking neural network should be consistent with the actual circuit behavior.

An example object of the present invention is to provide a computing device, a neural network system, a neuron model device, a computation method, and a trained model generation method that can solve the above-mentioned problems.

### Means for Solving the Problem

According to the first example aspect of the present invention, a computing device includes a multilayer spiking neural network including a plurality of neurons, and includes an additive computing portion in which a lower limit of membrane potential of the neurons in each layer is suppressed by learning.

According to the second example aspect of the present invention, a neural network system includes a multilayer spiking neural network including a plurality of neurons, and includes an additive computing portion in which a lower limit of membrane potential of the neurons in each layer is suppressed by learning.

According to the third example aspect of the present invention, a neuron model device forms a multilayer spiking neural network including a plurality of neurons, and includes an additive computing portion in which a lower limit of membrane potential of the neurons in each layer is suppressed by learning.

According to the fourth example aspect of the present invention, a computation method by a multilayer spiking neural network including a plurality of neurons, includes an additive computation in which a lower limit of membrane potential of the neurons in each layer is suppressed by learning.

According to the fifth example aspect of the invention, a trained model generation method for a multilayer spiking neural network including a plurality of neurons includes an additive computation in which a lower limit of membrane potential of the neurons in each layer is suppressed by learning.

### Effect of Invention

According to the invention, the operation of the circuit model corresponding to each neuron model comprising the spiking neural network can be consistent with the actual circuit operation.

### BRIEF DESCRIPTION OF THE DRAWINGS

FIG. 1 is a diagram showing an example of the configuration of a neural network device according to the example embodiment.

FIG. 2 is a diagram showing an example of the configuration of a spiking neural network equipped with a neural network device according to the example embodiment.

FIG. 3 is a diagram showing an example of the temporal variation of the membrane potential in a spiking neuron model in which the timing of the spike signal output is not restricted according to the example embodiment.

FIG. 4 is a configuration diagram showing an example of a spiking neuron model.

FIG. 5A is a diagram for illustrating the change in membrane potential in the comparative example.

FIG. 5B is a diagram for illustrating the change in membrane potential in the comparative example.

FIG. 6 is a diagram for illustrating the learning method that regularizes using a weight according to the example embodiment.

FIG. 7 is a diagram for illustrating the learning method that regularizes using membrane potential according to the example embodiment.

FIG. 8A is a diagram for illustrating the membrane potential when applying the learning method that regularizes using the membrane potential according to the example embodiment.

FIG. 8B is a diagram for illustrating the membrane potential when applying the learning method that regularizes using the membrane potential according to the example embodiment.

FIG. 9 is a diagram showing an example of the system configuration during learning in the example embodiment.

FIG. 10 is a diagram showing an example of signal input/output in the neural network system 1 according to the example embodiment.

FIG. 11 is a diagram showing an example of signal input/output in a neural network device during operation in the example embodiment.

FIG. 12 is a schematic block diagram showing the configuration of the computer according to the second example embodiment.

### EXAMPLE EMBODIMENT

The following is a description of example embodiments of the present invention, but the following example embodiments do not limit the invention according to the claims. Not all of the combinations of features described in the example embodiments are essential to the solution of the invention.

### First Example Embodiment

FIG. 1 is a diagram showing an example configuration of a neural network device according to the example embodiment. In the configuration shown in FIG. 1, a neural network device 10 (computing device) includes a neuron model 100. The neuron model 100 includes an index value calculation portion 110, a comparison portion 120, and a signal output portion 130. The neuron model 100 is an example of a neuron model device.

The neural network device 10 uses a spiking neural network to process data. The neural network device 10 is an example of a computing device.

A neural network device here is a device in which a neural network is implemented. The spiking neural network may be implemented in the neural network device 10 using dedicated hardware. For example, a spiking neural network may be implemented in the neural network device 10 using an Application Specific Integrated Circuit (ASIC) or Field Programmable Gate Array (FPGA). Alternatively, the spiking neural network may be implemented in the neural network device 10 through software, using a computer or other means.

Devices with ASICs, devices with FPGAs, and computers are all examples of programmable devices. In an ASIC and FPGA, describing hardware using a hardware description language and realizing the described hardware on an ASIC or FPGA is an example of programming. When the neural network device 10 is configured using a computer, the functions of the spiking neural network may be described by programming and the resulting program may be executed by the computer. The following is an example of a spiking neural network realized using analog circuits and implemented in the neural network device 10. In the explanation, when describing the functional composition, there may be instances where an example of the configuration of the functional model (numerical analysis model) is provided for clarification.

A spiking neural network is a neural network that outputs signals with timing based on a state quantity called membrane potential, in which the output state of a neuron model varies with time according to the input status of signals to the neuron model itself. The membrane potential is also referred to as the index value of the signal output or simply the index value.

Time variation here refers to the change with time.

Neuron models in spiking neural networks are also referred to as spiking neuron models. The signals output by the spiking neuron model are also referred to as spike signals or spikes. In a spiking neural network, a binary signal can be used as a spike signal, and information can be transferred between spiking neuron models by the timing of spike signal transmission or the number of spike signals.

In the case of the neuron model 100, the index value calculation portion 110 calculates the membrane potential based on the input status of the spike signal to the neuron model 100. A signal output portion 130 outputs a spike signal at a timing corresponding to the time variation of the membrane potential.

Pulse signals may be used as spike signals in the neural network device 10, or step signals may be used, but spike signals are not limited thereto.

The following describes as an example the case in which a temporal method of transmitting information at the timing of spike signal transmission is used as the information transmission method between neuron models 100 in a spiking neural network implemented by the neural network device 10. However, the information transmission method between the neuron models 100 in the spiking neural network by the neural network device 10 is not limited to any particular method.

The processing performed by the neural network device 10 can be a variety of processes that can be performed using spiking neural networks. For example, the neural network device 10 may perform, but is not limited to, image recognition, biometric identification or numerical prediction.

The neural network device 10 may be configured as a single device or a combination of a plurality of devices. For example, the individual neuron models 100 may be configured as devices, and a spiking neural network may be configured by connecting devices (neuron model devices) constituting these individual neuron models 100 with signal transmission paths.

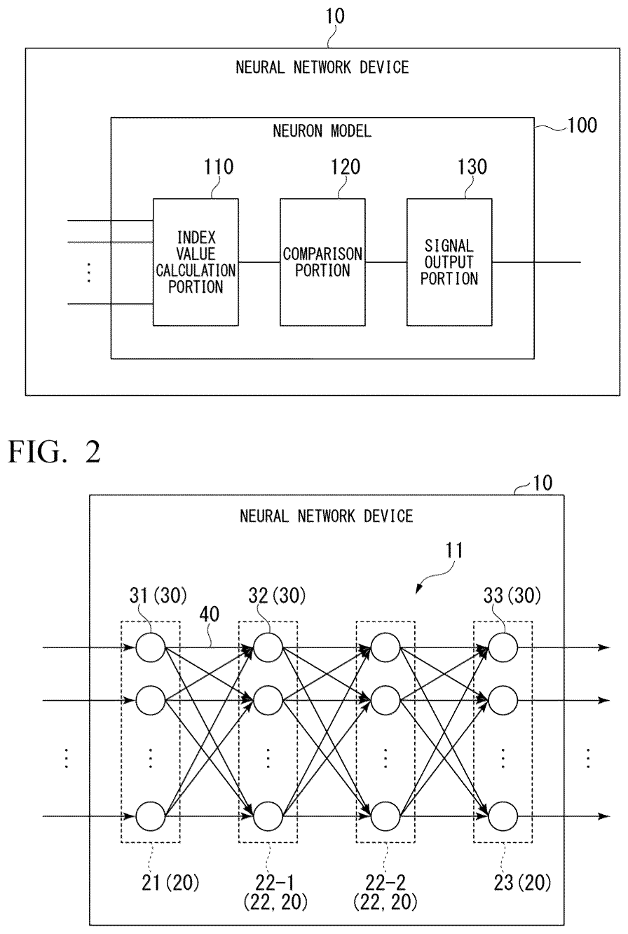

FIG. 2 is a diagram showing an example of the configuration of a spiking neural network provided by the neural network device 10. The spiking neural network provided by the neural network device 10 is also denoted as neural network 11. The neural network 11 is also referred to as a neural network body.

In the example in FIG. 2, the neural network 11 is configured as a feed-forward four-layer spiking neural network. Specifically, the neural network 11 includes an input layer 21, two intermediate layers 22-1 and 22-2, and an output layer 23. The two intermediate layers 22-1 and 22-2 are also collectively referred to as intermediate layers 22. The intermediate layers are also referred to as hidden layers. The input layer 21, intermediate layers 22, and output layer 23 are also collectively referred to as layers 20.

The input layer 21 includes an input node 31. The intermediate layers 22 include an intermediate node 32. The output layer 23 includes an output node 33. The input node 31, intermediate node 32, and output node 33 are also collectively denoted as nodes 30.

The input node 31, for example, converts input data to the neural network 11 into spike signals. Alternatively, if the input data to the neural network 11 is indicated by spike signals, the neuron model 100 may be used as the input node 31.

Any of the neuron models 100 may be used as the intermediate node 32 and the output node 33. The behavior of the neuron model 100 may differ between the intermediate node 32 and the output node 33, such as the constraints on spike signal output timing described below being more relaxed at the output node 33 than at the intermediate node.

The four layers 20 of the neural network 11 are arranged in the following order from upstream in signal transmission: input layer 21, the intermediate layer 22-1, the intermediate layer 22-2, and the output layer 23. Between two adjacent layers 20, the nodes 30 are connected by a transmission path 40. The transmission path 40 transmits spike signals from the node 30 in the upstream layer 20 to the node 30 in the downstream layer 20.

However, when the neural network 11 is configured as a feed-forward spiking neural network, the number of layers is not limited to four, but can be two or more. The number of neuron models 100 that each layer has is not limited to a specific number: each layer can have one or more neuron models 100. Each layer may have the same number of neuron models 100, or different layers may have different numbers of neuron models 100.

The neural network 11 may be configured in a fully connected configuration, but is not limited thereto. In the example in FIG. 2, all neuron models 100 in the layer 20 on the front side and all neuron models 100 in the layer 20 on the back side in adjacent layers may be connected by transmission paths 40, but some of the neuron models 100 in adjacent layers may not be connected to each other by the transmission paths 40.

In the description below, the delay time in the transmission of spike signals is assumed to be negligible, and the spike signal output time of the neuron model 100 on the spike signal output side and the spike signal input time to the neuron model 100 on the spike signal input side are the same. If the delay time in spike signal transmission is not negligible, the spike signal output time plus the delay time may be used as the spike signal input time.

The spiking neuron model outputs a spike signal when the time-varying membrane potential reaches a threshold value within a given period of time. In a typical spiking neural network where the timing of spike signal output is not restricted, when there are a plurality of data to be processed, it is necessary to wait for the input of the next input data to the spiking neural network until the spiking neural network receives an input of input data and outputs the computation result.

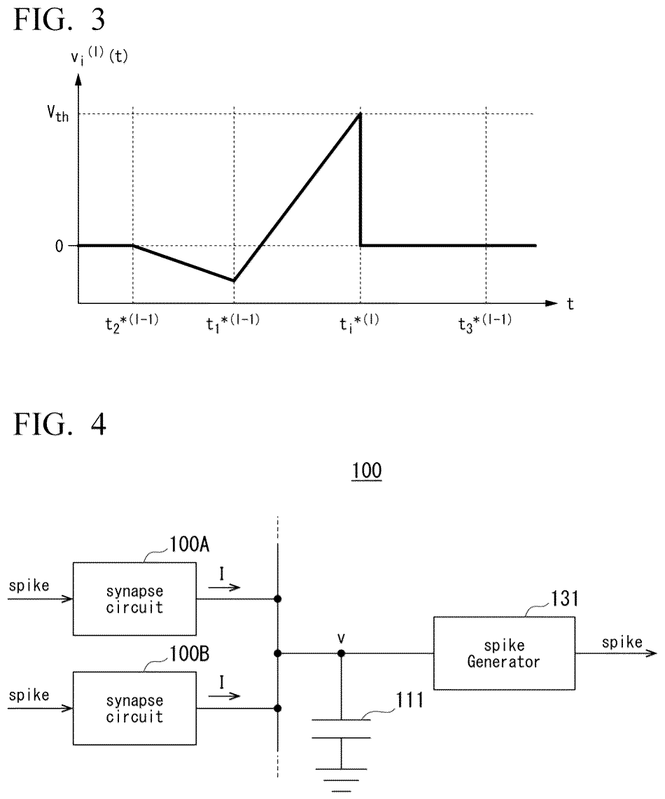

FIG. 3 is a diagram showing an example of the time variation of the membrane potential in a spiking neuron model in which the output timing of the spike signal is not restricted. The horizontal axis of the graph in FIG. 3A shows time. The vertical axis indicates membrane potential.

FIG. 3 shows an example of the membrane potential of a spiking neuron model of the i-th node in layer 1. The membrane potential at time t of the spiking neuron model of the i-th node in layer l is denoted as vi(l)(t). The spiking neuron model of the i-th node in layer 1 is also referred to as the target model in the description of FIG. 3. Time t indicates the elapsed time starting from the start time of the time interval allocated to the processing of layer 1.

In the example in FIG. 3, the target model is receiving spike signal inputs from three spiking neuron models.

Time t2*(l−1) indicates the input time of the spike signal from the second spiking neuron model in layer l−1. Time t1*(l−1) indicates the input time of the spike signal from the first spiking neuron model in layer l−1. Time t3*(l−1) indicates the input time of the spike signal from the third spiking neuron model in layer l−1.

The target model also outputs a spike signal at time ti*(l). The spiking neuron model's output of a spike signal is referred to as firing. The time at which the spiking neuron model fires is referred to as the firing time.

In the example in FIG. 3, the initial value of the membrane potential is set to 0.The initial value of the membrane potential corresponds to the resting membrane potential.

Before the target model fires, the membrane potential vi(l)(t) of the target model continues to change at a rate of change (change rate) according to the weight set for each spike signal transmission path after the spike signal is input. The rate of change of the membrane potential for each spike signal input is linearly additive. The differential equation for the membrane potential vi(l)(t) in the example in FIG. 3 is expressed as in Expression (1).

$$\begin{matrix}[ Expression 1 ] & \\ \frac{d}{d t} {v}_{i}^{( l )} ( t ) = {\sum }_{j} {w}_{i j}^{( l )} θ ( t - {t}_{j}^{* ( l - 1 )} ) & ( 1 )\end{matrix}$$

In Expression (1), wij(l) denotes the weight set on the transmission path of the spike signal from the j-th spiking neuron model in layer l−1 to the target model. The weight wij(l) is the subject of training. The weight wij(l) can take both positive and negative values.

θ is a step function and is shown in Expression (2). Therefore, the rate of change of the membrane potential vi(l)(t) changes while showing various values depending on the input status of the spike signal and the value of the weight wij(l), taking both positive and negative values in the process.

$$\begin{matrix}[ Expression 2 ] & \\ θ ( x ) = \{ \begin{matrix}0 , ( x < 0 \\ 1 , ( x ≧ 0 )\end{matrix} & ( 2 )\end{matrix}$$

For example, at time ti*(l), the membrane potential vi(l)(t) of the target model reaches the threshold Vth and the target model fires. The firing causes the membrane potential vi(l)(t) of the target model to be zero, and thereafter the membrane potential remains unchanged even when the target model receives a spike signal input.

The mathematical model shown in Expression (1) above is realized using a circuit model (analog circuit) based on Kirchhoff's rule. FIG. 4 is a configuration diagram showing an example of a spiking neuron model.

The neuron model 100 is an example of a spiking neuron model that includes an analog sum-of-products circuit. The range shown in FIG. 4 is part of the neuron model 100. For example, the neuron model 100 has synapse circuits 100A and 100B, a capacitor 111, and a spike generator 131. The neuron model 100 is an example of a neuron model that forms the neural network device 10.

The synapse circuits 100A and 100B, upon receiving a spike, respectively, flow a current I of a predetermined value. The current I is positive in the direction of output from the synapse circuits 100A and 100B. The current value is determined by learning, as described below. For example, the output stages of the synapse circuits 100A and 100B include a constant-current circuit that flows the current I, whose current value is adjusted for each of them. The current value, which is adjusted individually as the current I, is adjusted to a value associated with the correlation between the synapse circuits 100A and 100B and the neuron model 100 through learning.

The synapse circuits 100A and 100B are configured as input terminals of the neuron model 100. The input terminals of the neuron model 100 are connected to the first terminal of the capacitor 111 and the input terminal of the spike generator 131 inside neuron model 100. As a result, the first terminal of the capacitor 111 and the input terminal of the spike generator 131 are connected to each output terminal of the synapse circuits 100A and 100B. The second terminal of the capacitor 111 is connected to a pole of reference potential. The number of synapse circuits shown in FIG. 4 is two, but is not limited to this number.

The capacitor 111 is charged by the constant-current-controlled current I flowing from the synapse circuits 100A and 100B by being wired to the outputs of the synapse circuits 100A and 100B.

In the following, as in the description of the spiking neural network with reference to Expressions (1) and (2), the neuron model 100 of the i-th node in layer 1 is referred to as the target model, and the membrane potential of the target model is denoted as vi(l)(t).

The index value calculation portion 110 uses the following Expression (3) instead of the aforementioned Expression (1).

$$\begin{matrix}[ Expression 3 ] & \\ C \frac{d}{d t} {v}_{i}^{( l )} ( t ) = \sum {I}_{i j}^{( l )} ( t ) & ( 3 )\end{matrix}$$

Iij(l)(t) denotes the current value equivalent to the spike signal from the jth spiking neuron model in layer l−1 to the target model. This current value indicates the magnitude of the current flowing from the jth spiking neuron model in layer l−1 to a given transmission path in the target model. For example, the rate of change of the membrane potential vi(l)(t) at time t is a function of the current value Iij(l)(t). C in Expression (3) is the capacitance of the capacitor 111. The rate of change of the membrane potential vi(l)(t) is then calculated by a function using the current value Iij(l)(t). As described above, the current value Iij(l)(t) should be the target of learning. The current value flowing in the transmission path of spike signal from the jth spiking neuron model in layer l−1 to the target model is denoted as Iij(l).

Expression (3) above gives the rate of change of the membrane potential vi(l)(t). A detailed explanation of the above Expression (3) is given below.

The potential of the first terminal of the capacitor 111 is denoted as the membrane potential v. The membrane potential v can be specified as a function v(t) taking time t as a variable. In this case, the identification of the layers within the SNN is omitted from the description.

The spike generator 131 includes within it a comparator COMP, which is not shown in the figure. The first terminal of the capacitor 111 is connected to the input terminal of the spike generator 131, whose potential is the membrane potential v. The spike generator 131 identifies whether the membrane potential v has reached the predetermined threshold Vth by means of the comparator COMP. The spike generator 131 fires and outputs a spike when the membrane potential v reaches the predetermined threshold Vth.

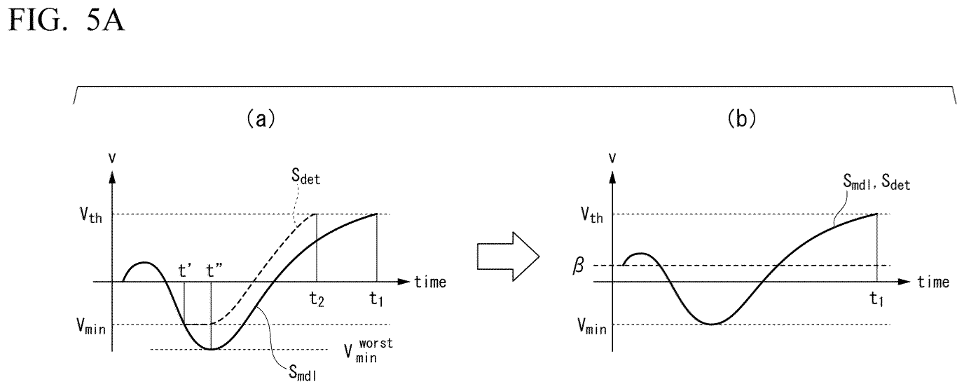

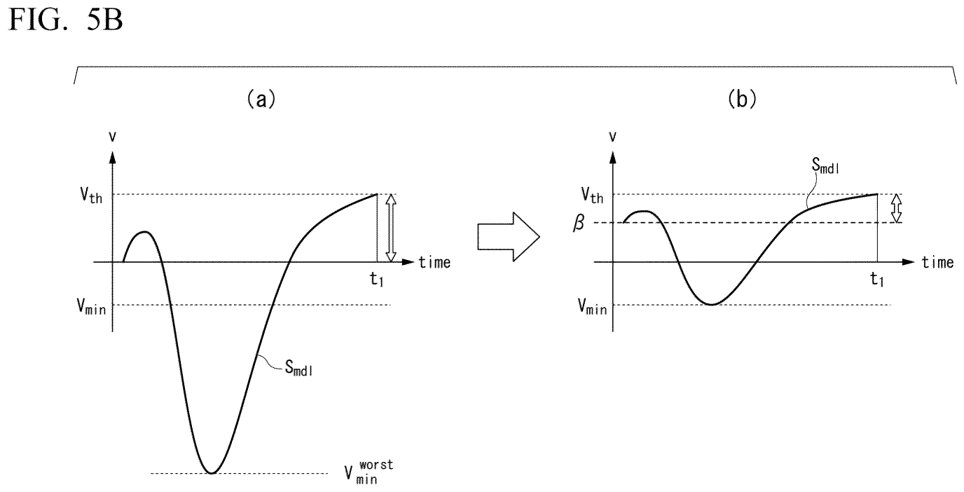

Referring to FIGS. 5A and 5B, the change in membrane potential in a comparative example is explained. FIGS. 5A and 5B illustrate the change in membrane potential in the comparative example. The horizontal axis of the graphs in FIGS. 5A and 5B shows time. The vertical axis indicates the membrane potential v.

(a) in each of FIG. 5A and FIG. 5B shows an example of an unadjusted membrane potential variation, while (b) in each of FIG. 5A and FIG. 5B shows an example of the results of limiting and adjusting the fluctuation of the membrane potential by a general method (comparative example).

When forming the neuron model 100 with an analog circuit as shown in FIG. 4, there is a voltage level at which the fluctuation of the membrane potential is restricted due to the effects of the power supply voltage for enabling the comparator COMP and other devices, protection circuits for semiconductor devices, and other factors.

For example, the voltage indicated by the waveform Smdl in (a) of each of FIGS. 5A and 5B varies between the lower voltage limit Vmin^{worst} and the threshold Vth. This waveform Smdl corresponds to the waveform from the numerical analysis model. In the case of this numerical model, the time when the membrane potential indicated by the waveform Smdl reaches the threshold value Vth is time t1.

Incidentally, the spike generator 131 may not be able to handle signals with voltages lower than the lower permissible limit voltage Vmin. In such cases, the membrane potential cannot be varied to the lower voltage limit Vmin^{worst}, as shown in the waveform Smdl in (a) of FIG. 5A. For example, if a membrane potential such as the solid waveform Smdl occurs, when the membrane potential reaches the lower permissible voltage limit Vmin, that membrane potential may be limited to the lower permissible voltage limit Vmin in or by the spike generator 131. In the example shown in (a) within FIG. 5A, this situation occurs at time t′.

The dashed waveform Sdet, shown in (a) of FIG. 5A simulates the observed values of the membrane potential in an actual circuit. This situation of the membrane potential being limited continues for as long as the conditions that act to reduce the membrane potential continue. At time t″, when the situation acting to lower the membrane potential more is interrupted, the membrane potential, indicated by the waveform Sdet, begins to rise from the lower permissible voltage limit Vmin. In this actual circuit, the time when the membrane potential indicated by the waveform Sdet reaches the threshold Vth is time t2. This time t2 is earlier than time t1 in the numerical analysis model.

In the case of this actual circuit, even though the allowable lower limit voltage Vmin can be changed by the circuit configuration to a level where the effect is less likely to occur, it is not possible to eliminate the limitation.

Therefore, to avoid this limitation in the voltage range of the membrane potential, one example of a countermeasure is to implement an adjustment (scaling) to reduce the amplitude of the membrane potential so that the lower limit of the membrane potential is not smaller than the allowable lower limit voltage Vmin. This is shown by the waveform Smdl in (b) of FIG. 5A and FIG. 5B. This scaling allows the lower limit of the membrane potential to be higher than the allowable lower limit voltage Vmin. In this case, the time when the membrane potential indicated by the waveform Sdet reaches the threshold value Vth is time t1.

This technique can eliminate the above problems. On the other hand, although an extreme case, this technique may result in a decrease of the resolution indicated by the membrane potential. For example, as shown in (a) of FIG. 5B, when the membrane potential swings significantly toward negative voltage, it falls under this case. To avoid this, the amplitude of the membrane potential can be adjusted (scaled) by increasing the reduction rate to keep the amplitude within the desired range, resulting in the membrane potential fluctuation shown in (b) of FIG. 5B.

However, this conversion will result in the loss of significant information on the amplitude level indicated by the waveform of the membrane potential. For example, the membrane potential could be obtained as a voltage from 0 to the threshold Vth before this conversion, but this conversion compresses the membrane potential to a voltage from B to the threshold Vth. This could result in reduced accuracy.

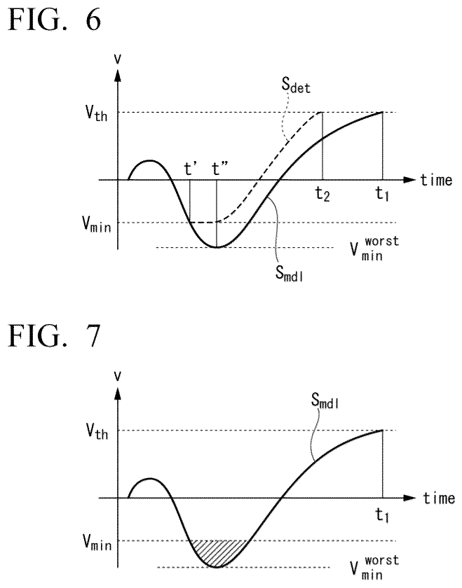

Therefore, referring to FIGS. 6 to 8B, two learning methods related to this example embodiment shall be described.

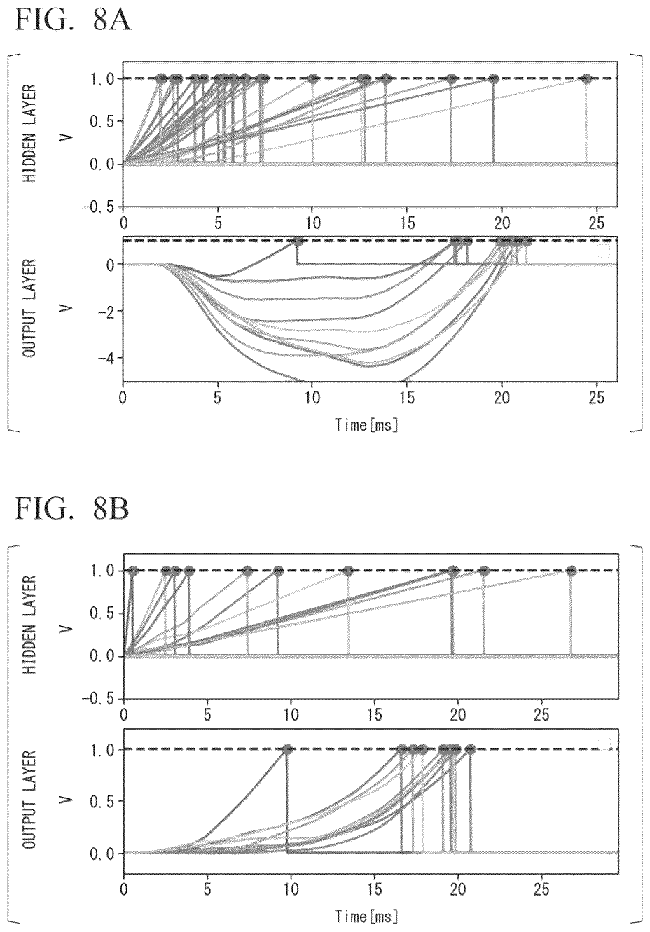

FIG. 6 is a diagram for illustrating the learning method that regularizes using a weight according to the example embodiment. FIG. 7 is a diagram for illustrating a learning method that regularizes using membrane potential according to the example embodiment. FIGS. 8A and 8B are drawings for illustrating the membrane potential when applying the learning method that regularizes using membrane potential. The graphs and waveforms shown in FIGS. 6 and 7 correspond to FIG. 5A above.

First, an overview of the “learning method that regularizes with a weight” shown in FIG. 6 shall be given. Regularization mentioned here is intended to suppress the generation of relatively large negative values. The tendency of the membrane potential to change depends on a weight coefficient that has been set. Therefore, it is recommended to define a weight coefficient for the case in which a membrane potential occurs that is smaller than the lower permissible limit voltage Vmin, as shown in FIG. 6, as unsuitable to cause the weight coefficient to be learned. In other words, the weight coefficients should be optimized by learning the weight coefficients so that membrane potentials smaller than the allowable lower limit voltage Vmin, as shown in FIG. 6, do not occur.

Next, an overview of the “learning method that regularizes using membrane potential” shown in FIG. 7 shall be given. Regularization mentioned here is to intend to suppress the generation of negative values of the membrane potential smaller than a predetermined value as a result of an excessive drop. In this case, it is recommended to define the generation of a membrane potential smaller than the lower permissible limit voltage Vmin, as shown in FIG. 7, as unsuitable and to cause it to be learned using a cost function based on the membrane potential.

Referring to FIGS. 8A and 8B, the response of the neuron model 100 as a result of the application of the “learning method that regularizes using membrane potential” shall be described.

FIG. 8A is a diagram for illustrating the results of applying the comparative example learning method. FIG. 8B is a diagram that illustrates the results of applying the “learning method that regularizes using membrane potential”. FIGS. 8A and 8B describe the waveforms of changes in the membrane voltage of several neurons.

FIGS. 8A and 8B show the results of experiments using the neural network device 10 to learn and test recognition of handwritten numeral images using MNIST, a data set of handwritten numeral images.

The configuration of the neural network 11 used for this test was a fully connected-feed-forward type with three layers: an input layer, a first layer, and an output layer. The number of neuron models 100 in the input layer was set at 784, the number of neuron models 100 in the first layer was set at 800, and the number of neuron models 100 in the output layer was set at 10.

The horizontal and vertical axes of the graphs in FIGS. 8A and 8B are mapped to FIG. 3, with the horizontal axis indicating the time when the membrane potential vi(l)(t) reaches the threshold Vth, by the time elapsed since the start of data input to the neural network 11. The vertical axis indicates the membrane potential of the neuron model 100.

The top graphs in FIGS. 8A and 8B show the membrane potential (Vmem) of each neuron in the preceding hidden layer of the output layer. The voltage level corresponding to the threshold Vth is normalized to 1. The graphs in the lower panels of FIGS. 8A and 8B show the membrane potential (Vmem) of each neuron in the output layer. The voltage level corresponding to the threshold Vth is normalized to 1.

The difference between FIG. 8A and FIG. 8B is that the regularization conditions during learning are different from each other. For example, the comparative example shown in FIG. 8A is the result of learning under conditions in which the negative membrane potential suppression regularization is disabled by setting the “negative membrane potential suppression regularization term γv” to 0, as described below. In contrast, the case shown in FIG. 8B is the result of learning under conditions in which negative membrane potential suppression regularization is enabled by setting a predetermined non-zero value for the “negative membrane potential suppression regularization term γv”. The allowable lower limit voltage Vmin in this case is 0 V.

Compare the output layer waveforms in FIGS. 8A and 8B. In FIG. 8A, negative voltages are generated in the output layer, while in FIG. 8B, no negative voltages are generated in the output layer. Regarding the timing of the firings, the most recent firings are represented well ahead of the other firings. This has been shown to be identifiable by the preceding spike.

The recognition rate for the comparative case in FIG. 8A was 98.48%, and the recognition rate for the case in FIG. 8B was 98.33%. As shown in FIG. 8B, there was no significant difference in recognition rate when learning with the “negative membrane potential suppression regularization term γv,” confirming that the range of membrane potential fluctuation in the output layer can be adjusted.

The details of each learning method that enabled the above identification are described in turn.

### Application Example of First Learning Method

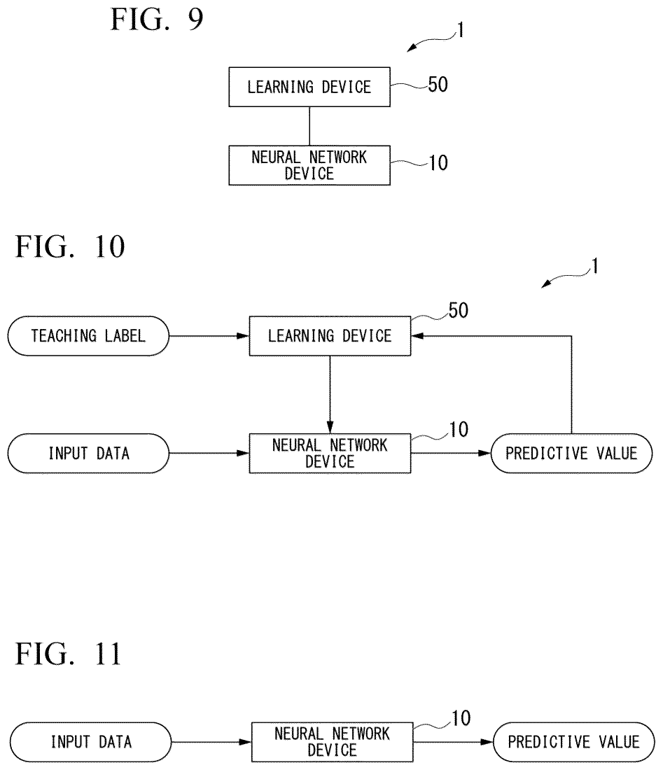

FIGS. 9 through 11 illustrate the application of the “leaming method that regularizes with weights” shown in FIG. 6.

FIG. 9 is a diagram showing an example of the system configuration during learning. In the configuration shown in FIG. 9, the neural network system 1 includes the neural network device 10 and a learning device 50. The neural network device 10 and the learning device 50 may be integrally configured as one device. Alternatively, the neural network device 10 and the learning device 50 may be configured as separate devices.

As mentioned above, the neural network 11 that the neural network device 10 comprises is also referred to as the neural network body.

The neural network device 10 in the neural network system 1 is equipped with an index value calculation portion 110 (additive computing portion), i.e., the neuron model 100.

The leaming device 50 generates a trained model for determining the responsiveness of the membrane potential of the neuron model 100 to the above currents.

The index value calculation portion 110 of the neuron model 100 may have the lower limit of the membrane potential of neurons of each layer suppressed by learning.

FIG. 10 is a diagram showing an example of signal input/output in neural network system 1. In the example in FIG. 10, input data and a teaching label indicating the correct answer to the input data are input to the neural network system 1. The neural network device 10 may receive the input of the input data, and the learning device 50 may receive the input of the teaching label. The combination of the input data and teaching label corresponds to an example of training data in supervised learning.

The neural network device 10 receives the input data and outputs an estimate based on the input data.

The learning device 50 performs learning of the neural network device 10. Learning here refers to adjusting the parameter values of the learning model by machine learning. The learning device 50 performs learning of a weight coefficient for the spike signal input to the neuron model 100. The weight Wij(l) in Expression (4) corresponds to an example of a weight coefficient whose value is adjusted by the learning device 50 through training. The weight Wij(l) in Expression (4) corresponds to, for example, the current value Iij(l) of the current flowing through the analog circuit and the conductance of the circuit. The following explanation uses the weight Wij(l).

The learning device 50 may perform learning of weight coefficients so that the magnitude of the error between the estimated value and the correct value indicated by the teaching label is reduced, using an evaluation function that indicates an evaluation of the error between the estimated value output by the neural network device 10 and the correct value.

The learning device 50 is an example of a learning means. The learning device 50 is composed of, for example, a computer.

For example, machine learning methods, reinforcement learning methods, deep reinforcement learning methods, and the like may be applied as learning methods by the leaming device 50. More specifically, the learning device 50 may learn the characteristic value of the index value calculation portion 110 so that the gain is maximized under predefined conditions, following the method of reinforcement learning (deep reinforcement learning).

Existing learning methods such as error back propagation, for example, can be used as the learning method performed by the learning device 50.

For example, when the learning device 50 performs learning using the error back propagation method, the weights Wij(l) may be updated so that the weights Wij(l) is changed by the change amount ΔWij(l) shown in Expression (12).

$$\begin{matrix}[ Expression 4 ] & \\ Δ {w}_{i j}^{( l )} = - η \frac{\partial C}{\partial {w}_{i j}^{( l )}} & ( 4 )\end{matrix}$$

η is a constant that indicates the learning rate. The learning rates in Expression (4) may be the same or different from each other.

C is expressed as in Expression (5).

$$\begin{matrix}[ Expression 5 ] & \\ C := - {\sum }_{i = 1}^{{N}^{( M )}} {κ}_{i} ln ( {S}_{i} ( {t}^{( M )} ) ) + \frac{γ}{2} ( {t}_{i}^{( M )} - {t}^{( ref )} ) + {γ}_{v} \times Q & ( 5 )\end{matrix}$$

The first term in C corresponds to an example of an evaluation function that indicates the evaluation for errors between the estimated value output by the neural network device 10 and the correct value indicated by the teaching label. The first term of C is set as a loss function that outputs a smaller value the smaller the error.

M represents an index value indicating the output layer (final layer). N(M) represents the number of neuron models 100 included in the output layer.

κi represents the teaching label. Here, the neural network device 10 is assumed to perform class classification of N(M) number of classes, and that the teaching label is denoted by one-hot vector. It is assumed that κi=1 when the value of index i indicates the correct class, and κi=0 otherwise.

t(ref) represents the reference spike.

The term “γ/2(ti(M)-t(ref))²” is a term provided to avoid learning difficulties. This term is also called the Temporal Penalty Term. γ is a constant to adjust the influence of the Temporal Penalty Term, and γ>0. γ is also called the Temporal Penalty Coefficient.

The “γv×Q” is an adjustment term in order to regularize so that a large negative membrane potential does not occur. This Q is the regularization term that suppresses negative membrane potentials. γv is the coefficient of the regularization term Q that suppresses the negative membrane potential. More specific examples of this regularization term are discussed below.

Si is a softmax function and is expressed as in Expression (6).

$$\begin{matrix}[ Expression 6 ] & \\ {S}_{i} ( {t}^{( M )} ) := \frac{exp ( - \frac{{t}_{i}^{* ( M )}}{{σ}_{soft}} )}{{\sum }_{j = 1}^{{N}^{( M )}} exp ( - \frac{{t}_{i}^{* ( M )}}{{σ}_{soft}} )} & ( 6 )\end{matrix}$$

σsoft is a constant established as a scale factor to adjust the magnitude of the value of the softmax function Si, where σsoft>0.

For example, the spike firing time of the output layer may indicate, for each class, the probability that the classified object indicated by the input data is classified into that class. For i where κi=1, the smaller the value of ti(M), the smaller the value of the term “−Σi=1N(M) (κiln (Si(t(M))))”, and the learning device 50 calculates the loss (the value of the evaluation function C) to be small.

However, the processing performed by the neural network device 10 is not limited to class classification.

Next, the regularization term Q to avoid the occurrence of large negative membrane potentials shall be described.

For example, the regularization term Q above may be specified as in the following Expression (7).

$$\begin{matrix}[ Expression 7 ] & \\ Q = {\sum }_{i , j} {w}_{i j}^{2} & ( 7 )\end{matrix}$$

The above Expression (7) for the regularization term Q is an example of a regularization term Q that is a power of the absolute value of the weight Wij(l) (weight coefficient) shown on the right-hand side and includes the operation of a power of any natural number as a power exponent. More specifically, the regularization term Q shown in Expression (7) is one that involves the operation of squaring the weight Wij(l) (weight coefficient).

The index value calculation portion 110 (additive computing portion) of the neural network device 10 can suppress excessive fluctuations of the membrane potential v by being trained using the cost function in Expression (7). This index value calculation portion 110 should suppress excessive fluctuations in the membrane potential by being trained to include in the solution of the cost function the result of the calculation of the power of the weight Wij(l) (weight coefficient) as described above, with any natural number as the power exponent.

FIG. 11 is a diagram showing an example of signal input/output in the neural network device 10 during operation.

As in the operation shown in FIG. 10, during learning, the neural network device 10 receives the input of input data and the neural network device 10 outputs estimates based on the input data.

According to the example embodiment, the neural network device 10 (computing device) is equipped with a multilayer spiking neural network (SNN) that includes a plurality of neurons. The neural network device 10 includes an index value calculation portion 110 (additive computing portion) in which the lower limit of the membrane potential of neurons in each layer is suppressed by learning. This aligns the operation of the circuit model corresponding to each neuron model that makes up the multilayer spiking neural network with the actual circuit operation.

The following is a variant of the regularization term Q of the first learning method.

The following Expression (8) may be applied as the regularization term Q instead of the above Expression (7).

$$\begin{matrix}[ Expression 8 ] & \\ Q = {\sum }_{i , j} {w}_{i j}^{2} θ ( - {w}_{i j} ) & ( 8 )\end{matrix}$$

In the case of Expression (7) above, the value of the regularization term Q is larger when the magnitude of the weight Wij(l) (weight coefficient) is relatively large. This will provide for a larger penalty. In Expression (8) of this modification, the value of the regularization term Q is larger when the weight Wij(l) is negative and the magnitude thereof is relatively large. This allows for a larger penalty if the negative value weight Wij(l) is relatively large, independent of the magnitude of the positive value weight Wij(l).

The following Expression (9) may be applied as the regularization term Q.

$$\begin{matrix}[ Expression 9 ] & \\ Q = {\sum }_{i , j , l} {\vert {w}_{ij}^{( l )} \vert}^{p} θ ( - {w}_{i j}^{( l )} ) & ( 9 )\end{matrix}$$

In the case of Expression (9) of this modification, the value of the regularization term Q is larger when the weight Wij(l) is negative and the magnitude thereof is relatively large. The regularization term Q shown in Expression (17) is an example of a regularization term Q that includes the operation of the power of the absolute value of the weight Wij(l). The exponent P of the power of the right-hand side of this Expression (9) may be any natural number. Even in the case of using such an Expression (9), this allows for a larger penalty if the negative value weight Wij(l) is relatively large, independent of the magnitude of the positive value weight Wij(l).

### Application Example of Second Learning Method

A detailed example of the “learning method that regularizes using membrane potential” shown in FIG. 7 shall be given.

This second learning method also uses Expression (5), which indicates the learning rate described above.

Here, the following Expression (10) is used to define the regularization term Q instead of Expressions (7) through (9) above.

$$\begin{matrix}[ Expression 10 ] & \\ Q = {\int }_{0}^{T} {( v ( t ) - {V}_{min} )}^{2} θ ( {V}_{min} - v ( t ) ) d t & ( 10 )\end{matrix}$$

In Expression (10) above, T is the period of time from the start to the end of the simulation (referred to as the simulation agency). This Expression (10) shows that the value of the regularization term Q is integrated over the simulation period. The regularization term Q to be integrated here corresponds to the area of the hatched area in the graph in FIG. 7. In other words, it is the integral of the difference between the membrane potential v(t) and the threshold voltage Vmin during the period when the membrane potential is lower than the threshold voltage Vmin.

According to this, the regularization term Q is a function that has a non-zero value when the membrane potential v falls below a certain value. The regularization term Q is an example of a function that has a non-zero value when the membrane potential v(t) is below the threshold voltage Vmin. It is best to learn by using such a cost function that includes such a regularization term Q. It is possible to suppress the membrane potential by being learned using the cost function.

Expression (10) above is defined for a continuous-time system. Alternatively, the regularization term Q can be defined in a discrete-time system. Expression (11), shown next, defines an approximate solution by converting the continuous-time system, Expression (10), to a discrete-time system.

$$\begin{matrix}[ Expression 11 ] & \\ Q := {{\sum }_{p = 0}}^{P - 1} {( v ( {t}_{p} ) - {V}_{min} )}^{2} θ ( {V}_{min} - v ( {t}_{p} ) ) & ( 11 )\end{matrix}$$

The variable tp in Expression (11) above indicates a discretized time, as shown in Expression (12) below. The threshold voltage Vmin is denoted as Vm.

$$\begin{matrix}[ Expression 12 ] & \\ {t}_{i} := \frac{T}{P} i , ( i = 0 , 1 , … , P - 1 ) & ( 12 )\end{matrix}$$

According to Expression (11) above, the regularization term Q is differentiable as shown in Expression (13) below.

$$\begin{matrix}[ Expression 13 ] & \\ \frac{\partial Q}{\partial {w}_{i j}^{( l )}} = {\sum }_{p = 0}^{P - 1} ( v ( {t}_{p} ) - {V}_{min} ) θ ( {V}_{min} - v ( {t}_{p} ) ) \frac{\partial {v}_{i}^{( l )} ( {t}_{p} )}{\partial {w}_{i j}^{( l )}} & ( 13 )\end{matrix}$$

As described above, the regularization term Q is differentiable and can be learned efficiently.

For example, the membrane potential vi(l)(t) of each layer and each node can be derived by differentiating using Expression (14). This membrane potential vi(l)(t) is differentiable, and by differentiating it, Expression (15) is obtained.

$$\begin{matrix}[ Expression 14 ] & \\ {v}_{i}^{( l )} ( t ) = {\sum }_{j} {w}_{i j}^{( l )} ( t - {\hat{t}}_{j}^{( l - 1 )} ) θ ( t - {\hat{t}}_{j}^{( l - 1 )} ) & ( 14 )\end{matrix}$$

$$\begin{matrix}[ Expression 15 ] & \\ \frac{\partial {v}_{i}^{( l )} ( {t}_{p} )}{\partial {w}_{i j}^{( l )}} = ( t - {\hat{t}}_{j}^{( l - 1 )} ) θ ( t - {\hat{t}}_{j}^{( l - 1 )} ) & ( 15 )\end{matrix}$$

If the slope of the membrane potential vi(l)(t) can be derived comparably easily using this Expression (15), then regularization based on the membrane potential is possible.

According to the above example embodiment, the neural network 11 (computing device) is equipped with a multilayer spiking neural network that includes a plurality of neuron models 100 (neurons). The lower limit value of the membrane potential of the neuron model 100 in each layer is suppressed by learning in the index value calculation portion 110 (additive computing portion). This can align the operation of the circuit model corresponding to each neuron model 100 that makes up the spiking neural network with the actual circuit operation.

The configuration of the neuron model 100 as a spiking neuron model is also not limited to a specific configuration. For example, the neuron model 100 may not have a constant rate of change from the receipt of a spike signal input to the receipt of the next spike signal input.

The learning method of the neural network 11 is not limited to supervised learning. The learning device 50 may perform unsupervised learning of the neural network 11.

### Modification of Example Embodiment

When the neural network 11 is configured as a feed-forward spiking neural network, as described above, the number of layers of the neural network 11 need only be two or more, and is not limited to a specific number of layers. The number of neuron models 100 that each layer has is not limited to a specific number: each layer can have one or more neuron models 100. Each layer may include the same number of neuron models 100, or different layers may have different numbers of neuron models 100. The neural network 11 may or may not be fully-connected. For example, the neural network 11 may be configured as a convolutional neural network (CNN) with a spiking neural network.

The post-firing membrane potential of the neuron model 100 is not limited to those that do not change from the potential 0 described above. For example, after a predetermined time from firing, the membrane potential may change in response to the spike signal input. The number of times each of the neuron models 100 fires is also not limited to once per input data.

The configuration of the neuron model 100 as a spiking neuron model is also not limited to any particular configuration. For example, the neuron model 100 may not have a constant rate of change from the receipt of a spike signal input to the receipt of the next spike signal input.

### Second Example Embodiment

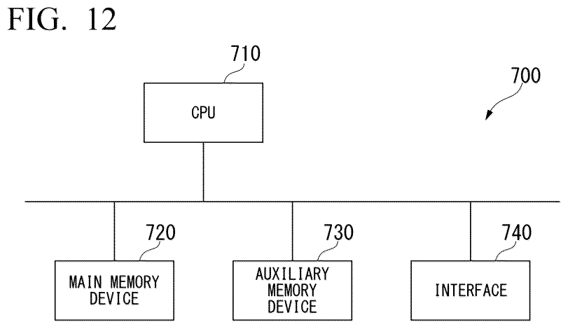

The second example embodiment shall be described with reference to FIG. 12. In the first example embodiment, the basic configuration example of the neuron model 100 was described. The present example embodiment describes several examples of applying this.

The index value calculation portion 110 varies the membrane potential over time based on the signal input status. To process multiple pieces of data, each data is processed at predetermined time intervals. To implement this process efficiently, the interval should be shortened.

FIG. 12 is a schematic block diagram showing the constitution of the computer according to at least one example embodiment.

In the configuration shown in FIG. 12, a computer 700 includes a CPU 710, a main memory device 720, an auxiliary memory device 730, an interface 740, and a nonvolatile recording medium 750.

Any one or more of the above neural network device 10, learning device 50, neural network device 610, neuron model device 620, and neural network system 630, or parts thereof, may be implemented in the computer 700. In that case, the operations of each of the above-mentioned processing portions are stored in the auxiliary memory device 730 in the form of a program. The CPU 710 reads the program from the auxiliary memory device 730, deploys it in the main memory device 720, and executes the above processing according to the program. The CPU 710 also reserves a storage area in the main memory device 720 corresponding to each of the above-mentioned storage portions according to the program. Communication between each device and other devices is performed by the interface 740, which has a communication function and communicates according to the control of the CPU 710.

When the neural network device 10 is implemented in the computer 700, the operations of the neural network device 10 and the various parts thereof are stored in the auxiliary memory device 730 in the form of a program. The CPU 710 reads the program from the auxiliary memory device 730, deploys it in the main memory device 720, and executes the above processing according to the program.

The CPU 710 also reserves a storage area in the main memory device 720 for processing of the neural network device 10 according to the program. Communication between the neural network device 10 and other devices is performed by the interface 740, which has a communication function and operates according to the control of the CPU 710. Interaction between the neural network device 10 and the user is performed by the interface 740 being equipped with a display device and input device, displaying various images according to the control of the CPU 710, and accepting user operations.

When the learning device 50 is implemented in the computer 700, the operation of the learning device 50 is stored in the auxiliary memory device 730 in the form of a program. The CPU 710 reads the program from the auxiliary memory device 730, deploys it in the main memory device 720, and executes the above processing according to the program.

The CPU 710 also reserves a storage area in the main memory device 720 for the processing of the learning device 50 according to the program. Communication between the learning device 50 and other devices is performed by the interface 740, which has a communication function and operates according to the control of the CPU 710. Interaction between the learning device 50 and the user is performed by the interface 740 being equipped with a display device and input device, displaying various images according to the control of the CPU 710, and accepting user operations.

When the neural network device 610 is implemented in the computer 700, the operations of the neural network device 610 and the various parts thereof are stored in the auxiliary memory device 730 in the form of a program. The CPU 710 reads the program from the auxiliary memory device 730, deploys it in the main memory device 720, and executes the above processing according to the program.

The CPU 710 also reserves a storage area in the main memory device 720 for processing of the neural network device 610 according to the program. Communication between the neural network device 610 and other devices is performed by the interface 740, which has a communication function and operates according to the control of the CPU 710. Interaction between the neural network device 610 and the user is performed by the interface 740 being equipped with a display device and input device, displaying various images according to the control of the CPU 710, and accepting user operations.

When the neuron model device 620 is implemented in the computer 700, the operations of the neuron model device 620 and the various parts thereof are stored in the auxiliary memory device 730 in the form of a program. The CPU 710 reads the program from the auxiliary memory device 730, deploys it in the main memory device 720, and executes the above processing according to the program.

The CPU 710 also reserves a storage area in the main memory 720 for the processing of the neuron model device 620 according to the program. Communication between the neuron model device 620 and other devices is performed by the interface 740, which has a communication function and operates according to the control of the CPU 710. Interaction between the neuron model device 620 and the user is performed by the interface 740 being equipped with a display device and input device, displaying various images according to the control of the CPU 710, and accepting user operations.

When the neural network system 630 is implemented in the computer 700, the operations of the neural network system 630 and the various parts thereof are stored in the auxiliary memory device 730 in the form of a program. The CPU 710 reads the program from the auxiliary memory device 730, deploys it in the main memory device 720, and executes the above processing according to the program.

The CPU 710 also reserves a storage area in the main memory device 720 for processing of the neural network system 630 according to the program. Communication between the neural network system 630 and other devices is performed by the interface 740, which has a communication function and operates according to the control of the CPU 710. Interaction between the neural network system 630 and the user is performed by the interface 740 being equipped with a display device and input device, displaying various images according to the control of the CPU 710, and accepting user operations.

A program for executing all or part of the processes performed by the neural network device 10, the learning device 50, the neural network device 610, the neuron model device 620, and the neural network system 630 may be recorded on a computer-readable recording medium, and by having the computer system read and execute the program recorded on this recording medium, the processing of each part may be performed by the computer system. The term “computer system” here shall include an operating system and hardware such as peripherals.

In addition, “computer-readable recording medium” means a portable medium such as a flexible disk, magneto-optical disk, ROM (Read Only Memory), CD-ROM (Compact Disc Read Only Memory), or other storage device such as a hard disk built into a computer system. The above program may be used to realize some of the aforementioned functions, and may also be used to realize the aforementioned functions in combination with programs already recorded in the computer system.

The above example embodiments of this invention have been described in detail with reference to the drawings. Specific configurations are not limited to these example embodiments, but also include designs, etc., to the extent that they do not depart from the gist of this invention.

### Reference Signs List

1, 630 Neural network system
10, 610 Neural network device
11 Neural network
21 Input layer
22 Intermediate layer
23 Output layer
24 Feature extraction layer
50 Learning device
100 Neuron model
100A, 100B Synapse circuit
111 Capacitor
131 Spike generator
110 Index value calculation portion
120 Comparison portion
130 Signal output portion
620 Neuron model device

What is claimed is:

1. A computing device comprising:
a multilayer spiking neural network including a plurality of neurons,
wherein a lower limit of membrane potential of the neurons in each layer is suppressed by learning.

2. The computing device according to claim 1,
wherein the plurality of neurons include a first neuron and a second neuron that are sequentially arranged in a direction in which a signal is guided, and
includes a weight coefficient of a weight addition operation that is determined by learning of the lower limit of the membrane potential based on association between the first neuron and the second neuron.

3. The computing device according to claim 2, wherein the membrane potential is suppressed by the learning using a cost function including an exponentiation operation of an absolute value of the weight coefficient, with an arbitrary natural number as an exponent.

4. The computing device according to claim 2, wherein the membrane potential is suppressed by the learning in which cost function includes a result of an exponentiation operation of an absolute value of the weight coefficient, with an arbitrary natural number as an exponent.

5. The computing device according to claim 4, wherein the membrane potential is suppressed by the learning using the cost function that includes a function which yields a non-zero value in a case where the membrane potential is taken below a certain value.

6. The computing device according to claim 2, wherein the membrane potential is suppressed by the learning in which a cost function includes a result of a function operation that yields a non-zero value in a case where the membrane potential is taken below a certain value.

7. A neural network system comprising:
a multilayer spiking neural network including a plurality of neurons,
wherein a lower limit of membrane potential of the neurons in each layer is suppressed by learning.

8. (canceled)

9. A computation method executed by a multilayer spiking neural network including a plurality of neurons, comprising:
suppressing a lower limit of membrane potential of the neurons in each layer by learning.

10. (canceled)
